(19) United States
(12) Patent Application Publication
(10) Pub. No.: US 2014/0326216 A1
(43) Pub. Date: Nov. 6, 2014

(54) METHOD AND APPARATUS FOR INCREASING DIESEL ENGINE EFFICIENCY

(71) Applicants: Jerry R. Shrum, Franklin, IN (US); J. Michael Jarvis, Franklin, IN (US)

(72) Inventors: Jerry R. Shrum, Franklin, IN (US); J. Michael Jarvis, Franklin, IN (US)

(21) Appl. No.: 13/886,657

(22) Filed: May 3, 2013

(51) Int. Cl. F02M 43/00; F02M 67/14

(52) U.S. Cl. CPC F02M 43/00; F02M 67/14
USPC 123/445

(57) ABSTRACT

A diesel engine enhancement assembly, including a microprocessor connected to the ECM, a control interface, a pump assembly connected to the microprocessor, an injector connected in fluidic communication the pump assembly and to an engine and the microprocessor, and a tank assembly connected to the pump assembly. The microprocessor initiates injection of predetermined amounts of combustion enhancing fluid into the engine when predetermined conditions are met.

### TECHNICAL FIELD

The present novel technology relates generally to internal combustion engines, and, more particularly, to a system for injecting liquid propane into a diesel engine to increase the efficiency thereof.

### BACKGROUND

The transport and distribution of commercial and industrial goods by diesel trucks remains vital to the U.S. economy, as well as to the economies of other countries. The trucking industry has traditionally played a vital role to the U.S. economy by providing a means for transport of both raw materials to manufacturers as well as of finished goods to commercial outlets, and now goods from distribution center warehouses directly to consumers via e-commerce. Diesel trucks are also important to the construction industry for moving building materials and concrete to construction sites, as well as moving dirt, rocks and rubbish away.

Recently, the U.S. Environmental Protection Agency tightened the emission standards for diesel trucks in order to further reduce airborne pollutants generated by their diesel engines. Diesel engines are traditionally fairly ‘dirty’, with particularly ‘sooty’ emissions.

Further, with diesel fuel prices at record highs, it is advantageous to increase diesel truck fuel economy. Attempts have been made to employ electric and/or hydraulic hybrid technology to diesel trucks with limited success. Hydraulic hybrid trucks store energy in hydraulic tanks and hydraulic motors, while electric hybrid vehicles store energy via batteries and regenerative brakes. While hybrid vehicles contribute energy savings of between about 30 and 60 percent over traditional diesel vehicles, drivers complain of less power available for hauling heavy loads.

Thus, there remains a need for a diesel truck offering increased fuel efficiency without sacrificing power. The present novel technology addresses this need.

### BRIEF DESCRIPTION OF THE DRAWINGS

FIG. 1 is a schematic view of a first embodiment engine efficiency enhancement system of the present novel technology.

### DETAILED DESCRIPTION OF THE PREFERRED EMBODIMENTS

For the purposes of promoting an understanding of the principles of the novel technology and presenting its currently understood best mode of operation, reference will now be made to the embodiments illustrated in the drawings and specific language will be used to describe the same. It will nevertheless be understood that no limitation of the scope of the novel technology is thereby intended, with such alterations and further modifications in the illustrated device and such further applications of the principles of the novel technology as illustrated therein being contemplated as would normally occur to one skilled in the art to which the novel technology relates.

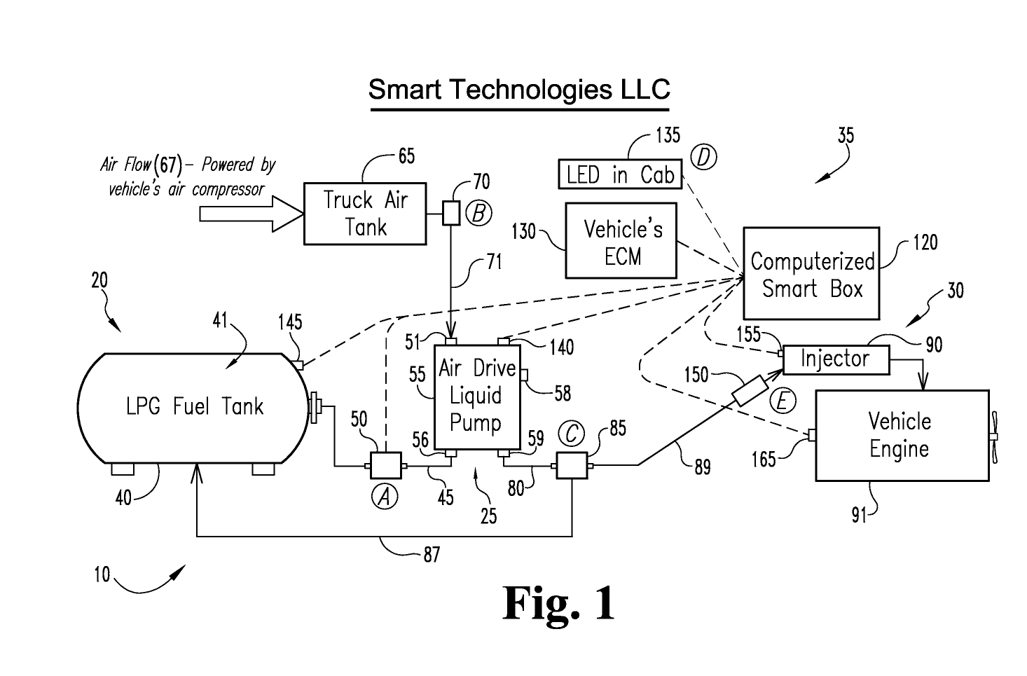

FIG. 1 relates to a first embodiment of the present novel technology, a system 10 for increasing the fuel efficiency of a diesel engine through the controlled injection of a combustion enhancing fluid thereinto. The system 10 includes a tank assembly 20, and air drive pump assembly 25, an injector assembly 30 and a control assembly 35 in cooperation with one another.

The tank assembly 20 includes a tank 40 for holding the combustion enhancing fluid 41. The combustion enhancing fluid 41 may be liquid propane, compressed natural gas, hydrogen, combinations thereof, or the like. Typically, the combustion enhancing fluid 41 is liquid propane, and the examples below typically discuss liquid propane as the combustion enhancing fluid 41 for illustrative purposes; however, no limitation of the fluid 41 composition is intended. The tank assembly 20 further includes a fluid conduit 45 extending to the pump assembly 25. An emergency shut-off valve is operationally connected to the fluid conduit 45.

The air drive pump assembly 25 includes an air drive liquid pump 55 having a combustion enhancing fluid inlet portion 56 connected in fluidic communication with the tank 40 through conduit 45. The pump 55 also includes an air supply inlet portion 57, and overpressure air release portion 58, and a combustion enhancing fluid outlet portion 59 connected in fluidic communication with fluid outlet line 60. Inlet portion 56 is connected in fluidic communication via inlet line 61 to vehicular air tank 65, which receives air from the vehicles' air compressor or like air source 67. An emergency check valve 70 is fluidically connected to the air line 71 connecting the air tank 65 and air drive pump inlet 57 in fluidic communication. A fluidic conduit 80 extends from the fluidic outlet 59 to an emergency pressure regulator 85. A tank return conduit 87 extends from the emergency pressure regulator 85 to the tank 40, while an injector conduit 89 extends in fluid communication between the regulator 85 and the injector 90.

The injector 90 is connected in fluidic communication with the diesel engine 91. Fluidic conduit 95 extends between the injector 90 and the engine 91, providing fluidic communication therebetween, and typically terminates in one or more nozzles 100 operationally connected to the engine 91, and more typically directly into the engine manifold.

A microprocessor or smart box 120 is connected in electric communication with the injector 90, the air drive liquid pump 55, the emergency shut off valve 50, the vehicular engine control module (ECM) 130, and a cab control interface 135. Typically, the microprocessor 120 is likewise electrically connected to an air pump sensor 140, a tank sensor 145, an injector sensor 155, and/or an engine sensor 165.

The system 10 is connected to a vehicle, such as a diesel semi-trailer truck, without disrupting the vehicle's normal mode of operation. When the system 10 is not engaged, the vehicle operates normally. The tank 40 and pump 55 are typically connected to the vehicle by connection members, such as brackets or the like. The injector 90 is typically operationally connected directly to the engine 91, and the smart box 120 is positioned in any convenient location and wired to the other components 50, 90, 130, 135, 140, 145, 155, 165.

In operation, the microprocessor 120 may be engaged to control the injection of predetermined amounts of combustion enhancing fluid 41, typically liquid propane, into the engine 91. The microprocessor 120 receives signals from the vehicle ECM 130 and/or sensors 140, 145, 155, 165 and calculates the power demand of the vehicle. When a predetermined set of conditions is met, such as when the vehicle is under acceleration, moving at a speed in a predetermined range, and the engine is turning over at a rate in falling within predetermined parameters, the microprocessor 120 energizes the injector 90 to supply liquid propane 41 pumped from the tank 40 into the engine 91 to increase engine efficiency and power. When the predetermined set of conditions is no longer in effect, the microprocessor 120 signals the injector 90 to cease injection of liquid propane into the engine 91.

Injection of predetermined amounts of liquid propane 41 into the engine 91 has the effect of increasing horsepower (typically an increase of from about 12% to 15%), increasing mileage (typically an increase of from about 18% to 25%), and reducing engine temperature by burning the diesel/propane mixture at a cooler temperature, which lowers exhaust temperature and provides a cleaner fuel burn.

In the event of a loss of air pressure in the system 10, check valve 70 engages to shut off air line 71 so as to not deplete vehicular air supply 65. Emergency system shut off valve 50 is likewise automatically engaged in the event of tank 40 pressure exceeding predetermined parameters (such as the tank 40 running dry), and valve 50 may also be engaged by microprocessor 120, either automatically is predetermined conditions are met or manually by an operator through the operator interface 135. Emergency pressure regulator 85 engages automatically in the event of excess liquid propane pressure from the pump 55 to shunt some or all of the excess liquid propane 41 back to tank 40. Also, an emergency fuel injector shut off 150 is operationally connected to the injector 90 to disengage the injector 90 in the event of the injector 90 becoming stuck, unresponsive to the microprocessor 120, or otherwise operating outside a predetermined set of parameters.

In one embodiment, the components of the system 10, including the tank assembly 20, air drive pump assembly 25, injector assembly 30 and control assembly 35 are provided as a kit 200 for connection to a diesel vehicle for increasing its fuel efficiency.

While the novel technology has been illustrated and described in detail in the drawings and foregoing description, the same is to be considered as illustrative and not restrictive in character. It is understood that the embodiments have been shown and described in the foregoing specification in satisfaction of the best mode and enablement requirements. It is understood that one of ordinary skill in the art could readily make a nigh-infinite number of insubstantial changes and modifications to the above-described embodiments and that it would be impractical to attempt to describe all such embodiment variations in the present specification. Accordingly, it is understood that all changes and modifications that come within the spirit of the novel technology are desired to be protected.

What is claimed is:

1. A fuel efficiency enhancement assembly, comprising in combination:
a microprocessor;
a vehicular ECM operationally connected to the microprocessor;
a control interface connected in electric communication with the microprocessor;
an air drive liquid pump assembly operationally connected to the microprocessor and further comprising:
an air driven liquid pump;
an air inlet operationally connected to the air driven liquid pump;
and air release operationally connected to the air driven liquid pump;
a fluid inlet operationally connected to the air driven liquid pump;
a fluid outlet operationally connected to the air driven liquid pump;
an emergency check valve operationally connected to the air inlet;
an air supply operationally connected to the emergency check valve; and
an emergency pressure regulator connected in fluid communication with the fluid outlet;
an injector assembly operationally connected to the air drive pump assembly and further comprising:
an injector connected in fluidic communication with the emergency pressure regulator and connected in electric communication with the microprocessor;
a nozzle operationally connected to the injector;
wherein the nozzle is positioned in fluidic communication with an engine; and
a tank assembly operationally connected to the air drive liquid pump assembly and further comprising:
a tank for containing a quantity of combustion enhancing fluid;
an emergency shut off valve connected in fluidic communication with the tank and with the pump inlet and connected in electric communication with the microprocessor;
wherein the tank is connected in fluidic communication with the emergency pressure regulator; and
wherein the microprocessor initiates injection of predetermined amounts of combustion enhancing fluid into the engine when predetermined conditions are met.

2. The assembly of claim 1 wherein the combustion enhancing fluid is liquid propane.

3. The assembly of claim 1 wherein the air supply is a vehicular air tank.

4. A method of increasing the efficiency of a diesel engine having an ECM, comprising:
a) operationally connecting an injector to a diesel engine;
b) connecting a pump in fluidic communication with the injector;
c) connecting a tank in fluidic communication with the pump;
d) operationally connecting an electronic controller to the injector and to the pump and to an ECM;
e) filling the tank with a combustion enhancing fluid;
f) injecting predetermined amounts of combustion enhancing fluid into the engine when a set of predetermined conditions are met; and
g) operating the engine normally when the set of predetermined conditions is not met.

5. The method of claim 4 wherein the pump is an air drive liquid pump, and further comprising:
h) operationally connecting an air supply to the air drive liquid pump;
i) operationally connecting a check valve between the air supply and the air drive liquid pump.

6. The method of claim 4 further comprising
j) operationally connecting a pressure regulator between the pump and the injector; and
k) fluidically connecting the regulator to the tank;
wherein when pressure from the pump to the regulator exceeds a predetermined level, the regulator diverts fluid back to the tank.

7. The method of claim 4 and further comprising
l) operationally connecting a shut-off valve between the tank and the pump; and
m) operationally connecting the electronic controller to the shut-off valve.

8. A diesel engine enhancement assembly, comprising in combination:
a microprocessor positioned in a diesel truck and operationally connected to an engine control module;
a control interface connected in electric communication with the microprocessor;
a pump assembly operationally connected to the microprocessor and further comprising:
a pump;
an energy source operationally connected to the pump;
a fluid inlet portion positioned in the pump;
a fluid outlet portion positioned in the pump; and
a pressure regulator connected in fluid communication with the fluid outlet;
an injector connected in fluidic communication with the pressure regulator and in fluidic communication with an engine and connected in electric communication with the microprocessor; and
a tank assembly operationally connected to the pump assembly and further comprising:
a tank for containing a quantity of combustion enhancing fluid;
a shut off valve connected in fluidic communication with the tank and with the fluid inlet portion and connected in electric communication with the microprocessor;
wherein the tank is connected in fluidic communication with the pressure regulator.

9. A kit for increasing the efficiency of a diesel vehicle, comprising:
a microprocessor mountable in a diesel truck and operationally connectable to an engine control module;
a control interface connectable in electric communication with the microprocessor;
a pump assembly operationally connectable to the microprocessor and further comprising:
a pump;
a fluid inlet portion positioned in the pump;
a fluid outlet portion positioned in the pump; and
a pressure regulator connectable in fluid communication with the fluid outlet;
an injector connectable in fluidic communication with the pressure regulator and in fluidic communication with an engine and connectable in electric communication with the microprocessor; and
a tank assembly operationally connectable to the pump assembly and further comprising:
a tank for containing a quantity of combustion enhancing fluid;
a shut off valve connectable in fluidic communication with the tank and with the fluid inlet portion and connectable in electric communication with the microprocessor;
wherein the tank is connectable in fluidic communication with the pressure regulator.
